(19) United States
(12) Patent Application Publication
(10) Pub. No.: US 2007/0228611 A1
(43) Pub. Date: Oct. 4, 2007

(54) METHOD OF MAKING LONG FIBER-REINFORCED MOLDED PLASTIC PARTS

(75) Inventors: ANSGAR JAEGER, Lauf (DE); Sabine Pahlke, Ludwigshafen (DE)

Correspondence Address: HENRY M FEIEREISEN, LLC, 350 FIFTH AVENUE, SUITE 4714, NEW YORK, NY, 10118, US

(73) Assignee: Demag Ergotech GmbH, Schwaig (DE)

(21) Appl. No.: 11/737,940

(22) Filed: Apr. 20, 2007

Related U.S. Application Data
(63) Continuation of application No. PCT/EP05/55255, filed on Oct. 14, 2005.

(30) Foreign Application Priority Data
Oct. 20, 2004 (DE) 10 2004 051 250.7

(51) Int. Cl. B29C 45/00

(52) U.S. Cl. 264/328.18

(57) ABSTRACT

In a method for making long fiber-reinforced molded plastic parts, a continuous stand-reinforced melt is injected into a mold, after the latter has been closed, causing the mold to open until a predefined compression gap has been reached. The injection of long fiber-reinforced melt into the mold is continued and the mold is closed again. After permitting the long fiber-reinforced melt to cool down, the mold is opened and the end product removed. In this way, fibers can be introduced in a comparatively gentle manner into the mold and distributed therein, and fiber breakage and formation of surface marks are largely prevented.

### CROSS-REFERENCES TO RELATED APPLICATIONS

This application is a continuation of prior filed copending PCT International application no. PCT/EP2005/055255, filed Oct. 14, 2005, which designated the United States and has been published but not in English as International Publication No. WO 2006/042824 and on which priority is claimed under 35 U.S.C. §120, and which claims the priority of German Patent Application, Serial No. 10 2004 051 250.7, filed Oct. 20, 2004, pursuant to 35 U.S.C. 119(a)-(d), the contents of which are incorporated herein by reference in its entirety as if fully set forth herein.

### BACKGROUND OF THE INVENTION

The present invention relates to a method of making molded plastic parts from long fiber-reinforced thermoplastics, also called “LFT”.

Nothing in the following discussion of the state of the art is to be construed as an admission of prior art.

During processing of a long fiber-reinforced melt (LFT melt) by way of a conventional injection molding process, the fibers of the melt are subjected to substantial shearing, as the melt is injected into the mold. Shearing causes a shortening of the fibers, adversely affecting mechanical properties. In general, longer fibers exhibit better mechanical properties, when the fibers are sufficiently wetted with the melt. One approach to address this problem involves the injection of long fiber-reinforced melt into a mold having pre-enlarged wall thickness or per-enlarged cavity. In other words, the mold provides a greater flow gap. After charging the total shot amount of long fiber-reinforced melt, the mold is completely closed for a compression operation and the clamping unit is locked. The provision of a compression stage not only positively affects the fiber length but also diminishes warping of the involved molded parts. In addition, the injection pressure and in particular the cavity pressure decrease so that the necessary overall clamping force for producing the part is also lower. This is beneficial in particular when large and flat parts are involved. This approach, also called sequential compression, suffers however shortcomings as a result of jetting lines that form during the initial injection phase into the pre-enlarged cavity and cause marks on the final product. Further marks are also caused as a result of the size of the melt cake which forms when the long fiber-reinforced melt is injected into the mold which has opened to a predefined gap. This melt cake remains immobile momentarily and the long fiber-reinforced melt front freezes before the mold closes, i.e. before compression begins.

It would therefore be desirable and advantageous to provide an improved method of making long fiber-reinforced molded plastic parts to obviate prior art shortcomings and to prevent formation of marks without exposing the fibers to substantial shearing stress.

### SUMMARY OF THE INVENTION

According to one aspect of the present invention, a method of making a long fiber-reinforced molded plastic product by means of an injection molding machine, includes the steps of a) closing a mold, b) starting to inject a long fiber-reinforced melt into the mold and opening the mold until a predefined compression gap has been reached, c) continuing injection of long fiber-reinforced melt into the mold, d) closing the mold, e) allowing the long fiber-reinforced melt to cool down to form a finished molded product, f) opening the mold, and g) removing the finished molded product.

The present invention resolves prior art problems by carrying out the injection of the long fiber-reinforced melt parallel to the opening of the mold. As a result, the formation of jetting lines is prevented and the fibers are not or only insignificantly exposed to shearing stress so that fiber breakage is substantially avoided. In addition, the formation of other surface marks is prevented.

According to another feature of the present invention, the injection of the long fiber-reinforced melt and the opening of the mold may be realized substantially at the same time. Optionally, injection of the melt may also be executed as the mold undergoes a closing movement and reaches a predefined position, e.g. shortly before the mold is closed and the platens of the mold touch one another. It may be advantageous to initiate a closing of the mold, starting from the compression position, so long as the injection of the long fiber-reinforced melt is not yet over.

As there is always a “relative movement” between the melt cake and the mold, either as a result of a continuous injection of melt, while the mold is at a standstill, or as a result of a movement of the mold during or after conclusion of injection, the melt cake is never at a standstill so that the melt front cannot freeze and the formation of surface marks can thus be avoided.

As the mold is moved in closing position until the platens touch, the clamping unit can be precisely positioned and the mold can assume the desired state. For example, cores or slides can be properly positioned. In addition, in the event of back injection molding of decorative material, such as textiles, films, or the like, the decorative material can advantageously be preformed by the mold, as the mold closes. Initial closing of the mold has also the added benefit that no finished product from a preceding cycle or no foreign matter is present in the mold.

According to another feature of the present invention, the start of opening and/or the start of closing of the mold can be triggered in dependence on a screw position. Other options to start these movements include a start in dependence on the cavity pressure (mold inner pressure), or a time-dependent start, or a start in dependence on injection pressure. Through all this options, the compression profile can be programmed, thereby realizing a greater flexibility in the configuration of the compression process for providing a good surface quality.

According to another aspect of the present invention, a method of making a long fiber-reinforced molded plastic product by means of an injection molding machine, includes the steps of a) injecting a long fiber-reinforced melt into a mold, when the mold reaches a predefined position during a closing movement of the mold, before the mold is closed, b) continuing injection of long fiber-reinforced melt into the mold and opening the mold until a predefined compression gap has been reached, c) further continuing injection of long fiber-reinforced melt into the mold, d) closing the mold, e) allowing the long fiber-reinforced melt to cool down to form a finished molded product, f) opening the mold, and g) removing the finished molded product.

### BRIEF DESCRIPTION OF THE DRAWING

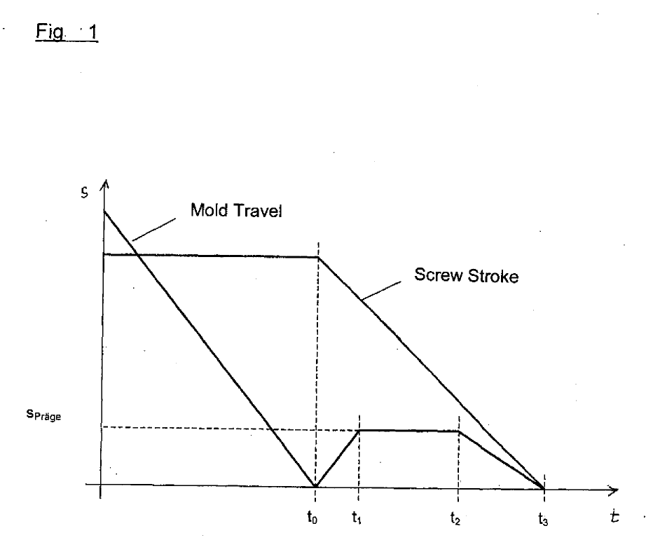

Other features and advantages of the present invention will be more readily apparent upon reading the following description of currently preferred exemplified embodiments of the invention with reference to the accompanying drawing, in which the sole FIG. 1 shows a graphical illustration of the mold travel or position and a screw stroke as a function of the time as well as the depiction of a compression gap S_{Präge}, in accordance with the present invention.

### DETAILED DESCRIPTION OF PREFERRED EMBODIMENTS

The depicted embodiment is to be understood as illustrative of the invention and not as limiting in any way.

Turning now to the sole FIG. 1, there is shown a graphical illustration of the mold travel or position and a screw stroke as a function of the time t as well as the illustration of a compression gap S_{Präge} which has been indicated by a horizontal broken line. It will be appreciated by persons skilled in the art that the mold and screw are components of an injection molding machine which is not shown in detail for the sake of simplicity because the basic construction of an injection molding machine involved here are generally known to the artisan.

At the start of an injection compression molding process, the mold is open and the screw assumes a position in which at least the shot volume of long fiber-reinforced melt is made available for this injection compression molding process. The mold can now be closed until the platens with attached mold halves of the injection molding machine touch one another. Movement of the platens may be implemented by suitable displacement cylinders. When the mold is closed to the final size of the cavity, indicated at time instance to, i.e. the cavity is not greater or smaller than the final cavity, the screw is advanced forwards, as indicated by the descending course of the screw stroke graph, and long fiber-reinforced melt is injected, causing the mold to open until the compression gap has been reached at time instance t₁. The mold is held in place for a predetermined period, from time instance t₁ to time instance t₂ for example, while the screw advances further and the injection process is continued. At time instance t₂, the mold undergoes a closing motion until the mold is closed again at time instance t₃ and the cavity has reached its final size. Injection of long fiber-reinforced melt may conclude at time instance t₃, as shown in FIG. 1, or also at an earlier time instance between time instance to and time instance t₂, or between time instance t₂ and time instance t₂. Optionally, injection of long fiber-reinforced melt may also be continued for a brief period, when the mold is closed, i.e. after time instance t₃.

The method according to the present invention can be implemented with any injection molding machine that has been suitably configured for executing an injection compression molding process. The injection molding machine may be dimensioned such that mold opening is solely attained by the injected long fiber-reinforced melt, i.e. the mechanism for displacing and clamping the mold is “idle”. Optionally, the displacement mechanism, such as for example the displacement cylinders are used to generate a controlled counterforce to slow down the mold opening in a desired manner. It is, however, also possible to use the displacement mechanism to actively assist a mold opening.

The mold may also include spring-loaded slides or cores, whereby the spring force can be used to assist mold opening or mold closing operations. When mold opening is involved, the afore-mentioned counterforce is used to oppose the spring force, while in mold closing the mold opening force applied by the long fiber-reinforced melt opposes the spring force. The spring force may be adjusted, and/or stops for the springs may be provided such that a displacement up to the compression position or originating therefrom can be implemented.

In connection with processing long fiber-reinforced thermoplastic material, the following should also be taken into consideration. The injection molding machine should be dimensioned to prevent or limit the presence of shearing stress. In other words, screw, backflow prevention valve, and nozzle have to be constructed accordingly. In particular, the screw should have a substantial L/D ratio. The machine parameters should be selected with a rate of injection which is as low as possible, slight holding pressure, slight rotation speed of the screw, and slight back pressure. Moreover, temperatures in the plasticizing cylinder should be individually adjustable, e.g. a higher temperature in the entry zone. Sometimes, it may be suitable, to pre-heat the pellets to increase the throughput. The mold and the gating system should have large flow cross sections and few melt deflections, and slight shrinkage and slight warping should be considered.

Examples of fiber material include glass fibers, carbon fibers, aramid fibers or also natural fibers. Most applications involve however the use of glass fibers.

The method according to the present invention is especially suitable in the automobile industry for producing relatively small components, like, e.g., pedal module, but also for producing very large components, like, e.g., underbody paneling, instrument panels, or seat structures such as backrest of the rear bench.

Tests of an underbody paneling showed for example that the produced parts are less warped and have superior mechanical characteristics but they can also be molded at significantly decreased clamping force. The user thus benefits significantly as far as quality and economics are concerned. Less warping permits precise installation of the underbody paneling with resultant benefits for a good c_{w} value so that the vehicle consumes less fuel. Reduced clamping force affords the user the option to utilize a smaller machine to produce the components, resulting in a further decrease in costs. The good mechanical characteristics may also be used to lower the content of glass fibers in the material and/or to reduce the wall thickness of the components. As a result, less material costs are experienced, cycle times are shortened, and the end product has less weight which in turn positively affects fuel consumption of the vehicle.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of making a long fiber-reinforced molded plastic part by means of an injection molding machine, comprising the steps of:
a) closing a mold;
b) starting to inject a long fiber-reinforced melt into the mold and opening the mold until a predefined compression gap has been reached;
c) continuing injection of long fiber-reinforced melt into the mold;
d) closing the mold;
e) allowing the long fiber-reinforced melt to cool down to form a finished molded product;
f) opening the mold; and
g) removing the finished molded product.

2. The method of claim 1, wherein step b) involves a substantial simultaneous injection of long fiber-reinforced melt and opening of the mold.

3. The method of claim 1, wherein step d) commences at the conclusion of step c).

4. The method of claim 1, wherein step d) commences before the conclusion of step c).

5. The method of claim 1, wherein step c) is terminated after step d).

6. The method of claim 1, wherein the mold is maintained in position for a predefined period, upon reaching the compression gap.

7. The method of claim 1, further comprising the step of triggering at least one step selected from the group consisting of step d) and step f) in dependence on a screw position, cavity pressure, time, or injection pressure.

8. The method of claim 1, wherein the opening of the mold in step b) is caused passively by the injected long fiber-reinforced melt.

9. The method of claim 8, further comprising the step of applying a controlled counterforce to slow down the opening of the mold in step b).

10. The method of claim 1, further comprising the step of back injecting a decorative material with long fiber-reinforced melt, with the decorative material being placed into the open mold and preformed, as the mold is closed.

11. A method of making a long fiber-reinforced molded plastic part by means of an injection molding machine, comprising the steps of:
a) injecting a long fiber-reinforced melt into a mold, when the mold reaches a predefined position during a closing movement of the mold, before the mold is closed;
b) continuing injection of long fiber-reinforced melt into the mold and opening the mold until a predefined compression gap has been reached;
c) further continuing injection of long fiber-reinforced melt into the mold;
d) closing the mold;
e) allowing the long fiber-reinforced melt to cool down to form a finished molded product;
f) opening the mold; and
g) removing the finished molded product.

12. The method of claim 11, wherein step b) involves a complete closing of the mold before the mold is allowed to open.

13. The method of claim 11, wherein step d) commences at the conclusion of step c).

14. The method of claim 11, wherein step d) commences before the conclusion of step c).

15. The method of claim 11, wherein step c) is terminated after step d).

16. The method of claim 11, wherein the mold is maintained in position for a predefined period, upon reaching the compression gap.

17. The method of claim 11, further comprising the step of triggering at least one step selected from the group consisting of step d) and step f) in dependence on a screw position, cavity pressure, time, or injection pressure.

18. The method of claim 11, wherein the opening of the mold in step b) is caused passively by the injected long fiber-reinforced melt.

19. The method of claim 18, further comprising the step of applying a controlled counterforce to slow down the opening of the mold in step b).

20. The method of claim 11, further comprising the step of back injecting a decorative material with long fiber-reinforced melt, with the decorative material being placed into the open mold and preformed, as the mold is closed.
